(19) United States
(12) Patent Application Publication
(10) Pub. No.: US 2023/0146238 A1
(43) Pub. Date: May 11, 2023

(54) THERMOPLASTIC POLYURETHANE RESIN SUITABLE FOR A LAMINATING PROCESS AND METHOD FOR PRODUCING THE SAME

(71) Applicant: NAN YA PLASTICS CORPORATION, TAIPEI (TW)

(72) Inventors: TE-CHAO LIAO, TAIPEI (TW); HAN-CHING HSU, TAIPEI (TW); CHEN-WEI CHANG, TAIPEI (TW)

(21) Appl. No.: 17/902,040

(22) Filed: Sep. 2, 2022

(30) Foreign Application Priority Data
Nov. 4, 2021 (TW) 110141061

(51) Int. Cl. C08L 75/06; C08G 18/12; C08G 18/42; C08G 18/32; C08G 18/28; C08J 5/18

(52) U.S. Cl. CPC C08L 75/06; C08G 18/12; C08G 18/4202; C08G 18/4238; C08G 18/3206; C08G 18/2825; C08J 5/18; C08L 2203/16; C08J 2375/06

(57) ABSTRACT

A thermoplastic polyurethane resin suitable for a laminating process and a method for producing the same are provided. The thermoplastic polyurethane resin is formed of an isocyanate component, a polyol component, a chain extender component, and a chain terminator component that is a monohydric alcohol via a polymerization reaction. The polyol component includes a first polyol having a number average molecular weight between 600 and 2,000 g/mol and a second polyol having a number average molecular weight between 1,500 and 3,000 g/mol. The chain extender component includes a first chain extender and a second chain extender. The first chain extender is a dihydric alcohol having a carbon chain length of C2-6, and a molecular structure thereof is linear and symmetrical. The second chain extender is a dihydric alcohol having a carbon chain length of C3-10, and a molecular structure thereof has a side chain and/or an ether group.

### CROSS-REFERENCE TO RELATED PATENT APPLICATION

This application claims the benefit of priority to Taiwan Patent Application No. 110141061, filed on Nov. 4, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a thermoplastic polyurethane resin, and more particularly to a thermoplastic polyurethane resin suitable for a laminating process and a method for producing the same.

### BACKGROUND OF THE DISCLOSURE

A thermoplastic polyurethane (TPU) resin is an environmentally friendly polymer. The thermoplastic polyurethane resin can be made into a film-like product through processes such as a laminating process, a film blowing process, a calendaring process, or a coating process. The film-like product made of thermoplastic polyurethane can have excellent tensile strength, elasticity, toughness, abrasion resistance, and cold resistance, and can also have eco-friendly and non-toxic properties. The film-like product can be widely used in footwear, sporting goods, ready-to-wear clothing, medical products, leather bags, toys, mountaineering supplies, bicycles, etc.

However, in the related art, some infusible small crystals are inevitably formed during production of the thermoplastic polyurethane. Accordingly, when a thermoplastic polyurethane resin currently available on the market is processed into a film by the laminating process, the film is prone to having abnormal characteristics (e.g., coarse grains, crystal points and flow marks), such that the appearance and the quality of a product is adversely affected. In addition, since the thermoplastic polyurethane resin currently available on the market has a wide molecular weight distribution and a large change in melt viscosity, the flow of a thermoplastic polyurethane melt tends to be non-uniform, thereby resulting in decreased physical properties of the product.

### SUMMARY OF THE DISCLOSURE

In response to the above-referenced technical inadequacies, the present disclosure provides a thermoplastic polyurethane resin suitable for a laminating process and a method for producing the same.

In one aspect, the present disclosure provides a thermoplastic polyurethane resin suitable for a laminating process. The thermoplastic polyurethane resin is formed from a reaction mixture via a polymerization reaction. The reaction mixture includes an isocyanate component, a polyol component, a chain extender component, and a chain terminator component. The polyol component includes a first polyol and a second polyol. The first polyol has a first number average molecular weight, the second polyol has a second number average molecular weight, the first number average molecular weight is between 600 g/mol and 2,000 g/mol, and the second number average molecular weight is between 1,500 g/mol and 3,000 g/mol. The first number average molecular weight is less than the second number average molecular weight, and a difference between the first number average molecular weight and the second number average molecular weight is between 500 and 1,000 g/mol. The chain extender component includes a first chain extender and a second chain extender. The first chain extender is a dihydric alcohol having a carbon chain length of C2 to C6, and a molecular structure of the first chain extender is linear and symmetrical. The second chain extender is a dihydric alcohol having a carbon chain length of C3 to C10, and a molecular structure of the second chain extender has at least a side chain and/or at least an ether group. The chain terminator component is a monohydric alcohol having a carbon chain length of C4 to C18.

In certain embodiments, based on a total weight of the reaction mixture being 100 parts by weight, an amount of the isocyanate component is between 30 parts by weight and 35 parts by weight, an amount of the polyol component is between 60 parts by weight and 65 parts by weight, an amount of the chain extender component is between 5 parts by weight and 10 parts by weight, and an amount of the chain terminator component is between 0.01 parts by weight and 0.05 parts by weight.

In certain embodiments, a weight ratio between the first polyol and the second polyol ranges from 8 to 12:48 to 52, and the first polyol having the first number average molecular weight facilitates in lowering a softening temperature of the thermoplastic polyurethane resin.

In certain embodiments, the first polyol is a first polyester polyol, and is at least one material selected from a group consisting of: poly(1,4-butylene adipate), polyethylene-1,4-butylene adipate glycol, and poly(1,6-hexamethylene adipate-succinic acid). The second polyol is a second polyester polyol, and is at least one material selected from the group consisting of: poly(1,4-butylene adipate), polyethylene-1,4-butylene adipate glycol, and poly(1,6-hexamethylene adipate-succinic acid).

In certain embodiments, a main chain of the first polyol and/or the second polyol is further branched by a short-chain diol to form an asymmetric molecular structure.

In certain embodiments, the first chain extender is at least one material selected from a group consisting of 1,4-butanediol and ethylene glycol, the second chain extender is at least one material selected from a group consisting of 2-methyl-1,3-propanediol, neopentyl glycol, 3-methyl-1,5-pentanediol, diethylene glycol, and dipropylene glycol, a weight ratio between the first chain extender and the second chain extender ranges from 4.5 to 4.75:0.25 to 0.5, and the second chain extender having the side chain and/or the ether group facilitates in reducing a crystallinity of the thermoplastic polyurethane resin.

In certain embodiments, the chain terminator component is at least one material selected from a group consisting of 1-butanol, 1-octanol, 1-dodecanol and 1-octadecanol.

In certain embodiments, an NCO/OH equivalent ratio of the reaction mixture in the polymerization reaction is between 0.98 and 1.02.

In certain embodiments, the thermoplastic polyurethane resin satisfies the following conditions: (1) a ratio (Mw/Mn) between a weight average molecular weight (Mw) and a number average molecular weight (Mn) of the thermoplastic polyurethane resin analyzed by a gel permeation chromatography (GPC) is between 1.250 and 1.300; (2) a crystallinity of the thermoplastic polyurethane resin analyzed by a differential scanning calorimeters (DSC) is between 10% and 30%; (3) a melt flow index (MFI) of the thermoplastic polyurethane resin is between 5 g/10 min (190° C.) and 8 g/10 min (190° C.); (4) a viscosity change rate of the thermoplastic polyurethane resin analyzed by a dynamic mechanical analyzer (DMA) under test conditions of a constant temperature of 190° C. and a shear rate of 0 to 1000 s⁻¹ is between 300 (Ns)/m² and 600 (Ns)/m²; and (5) a softening temperature of at least 95 wt. % of resin components in the thermoplastic polyurethane resin is lower than a laminating temperature of the laminating process. The softening temperature is between 150° C. and 180° C., and the laminating temperature is between 170° C. and 200° C.

In another aspect, the present disclosure provides a thermoplastic polyurethane resin suitable for a laminating process. A polymer chain of the thermoplastic polyurethane resin includes: at least one short chain segment, at least one long chain segment, at least one first extension segment, at least one second extension segment, and at least one chain termination segment. The short chain segment is formed of residues of a first polyol except for hydroxyl groups, the long chain segment is formed of residues of a second polyol except for hydroxyl groups, the first polyol has a first number average molecular weight, the second polyol has a second number average molecular weight, the first number average molecular weight is between 600 g/mol and 2,000 g/mol, the second number average molecular weight is between 1,500 g/mol and 3,000 g/mol, the first number average molecular weight is less than the second number average molecular weight, and a difference between the first number average molecular weight and the second number average molecular weight is between 500 g/mol and 1,000 g/mol. The first extension segment is formed of residues of a first chain extender except for hydroxyl groups, the second extension segment is formed of residues of a second chain extender except for hydroxyl groups, the first chain extender has a carbon chain length of C2 to C6, a molecular structure of the first chain extender is linear and symmetrical, the second chain extender has a carbon chain length of C3 to C10, and a molecular structure of the second chain extender has at least a side chain and/or at least an ether group. The chain termination segment is formed of residues of a chain terminator component except for hydroxyl groups, the chain terminator component is a monohydric alcohol having a carbon chain length of C4 to C18, and the chain termination segment is located at a tail end of the polymer chain.

In yet another aspect, the present disclosure provides a method for producing a thermoplastic polyurethane resin suitable for a laminating process. The method includes: adding an isocyanate component, a polyol component, and a chain extender component into an extruder, respectively, to form a reaction mixture; performing a polymerization reaction on the reaction mixture in the extruder to increase a molecular weight of the reaction mixture, so that the reaction mixture is formed into a thermoplastic polyurethane resin; and adding a chain terminator component into the extruder to terminate the polymerization reaction when the thermoplastic polyurethane resin reaches a predetermined molecular weight or a predetermined viscosity in the polymerization reaction. An NCO/OH equivalent ratio of the reaction mixture in the polymerization reaction is controlled to be between 0.98 and 1.02. The polyol component includes a first polyol and a second polyol, the first polyol has a first number average molecular weight, the second polyol has a second number average molecular weight, the first number average molecular weight is between 600 g/mol and 2,000 g/mol, and the second number average molecular weight is between 1,500 g/mol and 3,000 g/mol. The first number average molecular weight is less than the second number average molecular weight, and a difference between the first number average molecular weight and the second number average molecular weight is between 500 and 1,000 g/mol. The chain extender component includes a first chain extender and a second chain extender, the first chain extender is a dihydric alcohol having a carbon chain length of C2 to C6, and a molecular structure of the first chain extender is linear and symmetrical. The second chain extender is a dihydric alcohol having a carbon chain length of C3 to C10, and a molecular structure of the second chain extender has at least a side chain and/or at least an ether group. The chain terminator component is a monohydric alcohol having a carbon chain length of C4 to C18.

Therefore, in the thermoplastic polyurethane resin suitable for the laminating process and the method for producing the same provided by the present disclosure, by virtue of “the polyol component including a first polyol and a second polyol, the first polyol having a first number average molecular weight, the second polyol having a second number average molecular weight, the first number average molecular weight being between 600 g/mol and 2,000 g/mol, the second number average molecular weight being between 1,500 g/mol and 3,000 g/mol, the first number average molecular weight being less than the second number average molecular weight, and a difference between the first number average molecular weight and the second number average molecular weight being between 500 g/mol and 1,000 g/mol,” “the chain extender component including a first chain extender and a second chain extender, the first chain extender being a dihydric alcohol having a carbon chain length of from C2 to C6, a molecular structure of the first chain extender being linear and symmetrical, the second chain extender being a dihydric alcohol having a carbon chain length of from C3 to C10, and a molecular structure of the second chain extender having at least one side chain and/or at least one ether group,” and “the chain terminator component being a monohydric alcohol having a carbon chain length of from C4 to C18,” the thermoplastic polyurethane resin can have a narrow molecular weight distribution, a low softening temperature, and a small melt viscosity change rate. In addition, colloidal particles of the thermoplastic polyurethane resin can have good processability. After the thermoplastic polyurethane resin is processed into a film by the laminating process, the film does not have crystal points and flow marks, and can have good thickness uniformity and hydrolysis resistance.

These and other aspects of the present disclosure will become apparent from the following description of the embodiment taken in conjunction with the following drawings and their captions, although variations and modifications therein may be affected without departing from the spirit and scope of the novel concepts of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

[Thermoplastic Polyurethane Resin]

In the related art, some infusible small crystals are inevitably formed during production of the thermoplastic polyurethane. Accordingly, when a thermoplastic polyurethane resin currently available on the market is processed into a film by the laminating process, the film is prone to having abnormal characteristics (e.g., coarse grains, crystal points and flow marks), such that the appearance and the quality of a product is adversely affected. In addition, since the thermoplastic polyurethane resin currently available on the market has a wide molecular weight distribution and a large change in melt viscosity, the flow of a thermoplastic polyurethane melt tends to be non-uniform, thereby resulting in decreased physical properties of the product.

To solve the above-referenced technical inadequacies in the related art, an embodiment of the present disclosure provides a thermoplastic polyurethane resin (TPU resin), and more particularly a thermoplastic polyurethane resin suitable for a laminating process.

When the thermoplastic polyurethane resin of the present embodiment is formed into a thermoplastic polyurethane film (TPU film) by the laminating process, the abnormal characteristics (e.g., coarse grains, crystal points, and flow marks) of the film can be improved, and the film can have good physical properties.

To achieve this technical purpose, the thermoplastic polyurethane resin of the present embodiment is formed from a reaction mixture via a polymerization reaction. The reaction mixture includes an isocyanate component, a polyol component, a chain extender component, and a chain terminator component.

Based on a total weight of the reaction mixture being 100 parts by weight, an amount of the isocyanate component is between 30 parts by weight and 35 parts by weight, an amount of the polyol component is between 60 parts by weight and 65 parts by weight, an amount of the chain extender component is between 5 parts by weight and 10 parts by weight, and an amount of the chain terminator component is between 0.01 parts by weight and 0.05 parts by weight.

In some embodiments of the present disclosure, the isocyanate component is at least one material selected from a group consisting of: methylene diphenyl di-isocyanate (MDI), 4,4′-methylene di-cyclohexyl di-isocyanate (H12MDI), and isophorone di-isocyanate (IPDI), but the present disclosure is not limited thereto.

The polyol component includes a first polyol and a second polyol.

In some embodiments of the present disclosure, the first polyol may be, for example, a polyester polyol, a polyether polyol, a polycarbonate polyol, or a polycaprolactone polyol. Similarly, the second polyol may be, for example, a polyester polyol, a polyether polyol, a polycarbonate polyol, or a polycaprolactone polyol. In an exemplary embodiment of the present disclosure, the first polyol is a polyester polyol, and the second polyol is also a polyester polyol, but the present disclosure is not limited thereto.

In some embodiments of the present disclosure, the first polyol is a first polyester polyol, and is at least one material selected from a group consisting of: poly(1,4-butylene adipate), polyethylene-1,4-butylene adipate glycol, and poly(1,6-hexamethylene adipate-succinic acid). Similarly, the second polyol is a second polyester polyol, and is at least one material selected from the group consisting of: poly(1,4-butylene adipate), polyethylene-1,4-butylene adipate glycol, and poly(1,6-hexamethylene adipate-succinic acid).

It is worth mentioning that the poly(1,4-butylene adipate) (PBA) is formed of adipic acid and 1,4-butanediol through the polymerization reaction. The polyethylene-1,4-butylene adipate glycol is formed of adipic acid, ethylene glycol, and 1,4-butanediol through the polymerization reaction. The poly(1,6-hexamethylene adipate-succinic acid) is formed of adipic acid, succinic acid, and hexanediol through the polymerization reaction.

Further, material types of the first polyol and the second polyol may be the same as or different from each other, which is not limited in the present disclosure. The first polyol is mainly different from the second polyol in terms of the number average molecular weight (Mn).

In some embodiments of the present disclosure, the first polyol has a first number average molecular weight, and the second polyol has a second number average molecular weight. The first number average molecular weight of the first polyol is between 600 g/mol and 2,000 g/mol, the second number average molecular weight of the second polyol is between 1,500 g/mol and 3,000 g/mol, the first number average molecular weight is less than the second number average molecular weight, and a difference between the first number average molecular weight and the second number average molecular weight is between 500 g/mol and 1,000 g/mol. From another perspective, a carbon chain length of the first polyol having the first number average molecular weight is less than that of the second polyol having the second number average molecular weight.

In some embodiments of the present disclosure, a weight ratio between the first polyol and the second polyol ranges from 8 to 12:48 to 52, but the present disclosure is not limited thereto.

According to the above configuration, the first polyol having the first number average molecular weight facilitates in lowering a softening temperature of the thermoplastic polyurethane resin that is finally formed. The second polyol having the second number average molecular weight aids the thermoplastic polyurethane resin that is finally formed in maintaining a better mechanical strength.

It is worth mentioning that the “softening temperature” is a temperature at which a polymer resin sample reaches a specific deformation value under a certain stress and a certain condition (e.g., a sample size, a heating rate, and a method of applying an external force). The softening temperature is generally expressed as Ts. A measuring method of the softening temperature can be, for example, the Kofler bench method.

Further, when the thermoplastic polyurethane resin is formed into the thermoplastic polyurethane film through the laminating process, by lowering the softening temperature of the thermoplastic polyurethane resin, most of the thermoplastic polyurethane resin can be melted or softened at a laminating temperature of the laminating process. In this way, the abnormal characteristics (e.g., coarse grains, crystal points, and flow marks) of the TPU film in the related art can be improved.

It is worth mentioning that polymer crystallization is a process in which polymer chains are partially arranged During this process, the polymer chains are folded up to form ordered domains. A polymer can be crystallized from a melted state by cooling. However, a high crystallinity of the polymer will cause the TPU film to have the abnormal characteristics (e.g., coarse grains, crystal points, and flow marks).

In some embodiments of the present disclosure, to reduce the crystallinity of the thermoplastic polyurethane resin, the first polyol and/or the second polyol can also be, for example, grafted with at least one side chain on a main chain, so that a steric hindrance in arrangement of the polymer chains of the thermoplastic polyurethane resin is increased, and the crystallinity of the thermoplastic polyurethane resin is reduced. In this way, formation of the infusible small crystals can be avoided during the production of the thermoplastic polyurethane, and the abnormal situations of coarse grains, crystal points and flow marks of the TPU film in the related art can be further improved.

More specifically, the first polyol and/or the second polyol can be, for example, branched by a dihydric alcohol having a carbon chain length of C3 to C10. Accordingly, the first polyol and/or the second polyol can have an asymmetric molecular structure, the crystal configuration of the thermoplastic polyurethane resin can be adjusted, and the crystallinity of the thermoplastic polyurethane resin can be reduced.

The dihydric alcohol having the carbon chain length of C3 to C10 is a short-chain diol, and is at least one material selected from a group consisting of: diethylene glycol (DEG), 1,3-butanediol, 2-methyl-1,3-propanediol, neopentyl glycol, 1,6-hexanediol, and 3-methyl-1,5-pentanediol.

The chain extender component includes a first chain extender and a second chain extender.

In some embodiments of the present disclosure, the first chain extender is a dihydric alcohol having a carbon chain length of C2 to C6. A molecular structure of the first chain extender is linear and symmetrical. For example, the first chain extender is at least one material selected from a group consisting of: 1,4-butanediol (14BG) and ethylene glycol (EG). The first chain extender allows the thermoplastic polyurethane resin that is finally formed to have a better mechanical strength (such as rigidity and tensile strength), but the present disclosure is not limited thereto.

In some embodiments of the present disclosure, the second chain extender is a dihydric alcohol having a carbon chain length of C3 to C10. A molecular structure of the second chain extender has a side chain and/or an ether group. For example, the molecular structure of the second chain extender has the side chain, and the second chain extender is at least one material selected from a group consisting of: 2-methyl-1,3-propanediol, neopentyl glycol, and 3-methyl-1,5-pentanediol. The molecular structure of the chain extender with the side chain is shown in Table 1-1 below.

TABLE 1-1

| Material Type | Molecular Structure |
|---|---|
| 2-methyl-1,3-propanediol | 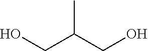 |
| neopentyl glycol | 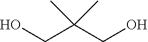 |
| 3-methyl-1,5 -pentanediol | 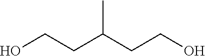 |

The molecular structure of the second chain extender has the ether group, and the second chain extender is at least one material selected from a group consisting of: diethylene glycol (DEG) and di-propylene glycol. The molecular structure of the chain extender with the ether group is shown in Table 1-2 below.

TABLE 1-2

| Material Type | Molecular Structure |
|---|---|
| diethylene glycol (DEG) | 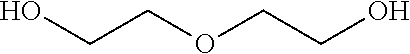 |
| di-propylene glycol | 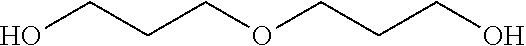 |

Since the molecular structure of the second chain extender has the side chain or the ether group, the steric hindrance in the arrangement of the polymer chains of the thermoplastic polyurethane resin that is finally formed is increased, and the crystallinity of the thermoplastic polyurethane resin is reduced. Accordingly, the formation of the infusible small crystals can be avoided during the production of the thermoplastic polyurethane, and the abnormal situations of coarse grains, crystal points, and flow marks of the TPU film in the related art can be further improved.

More specifically, the second chain extender will be formed into a hard segment in a polymer structure of the thermoplastic polyurethane resin after being polymerized. The second chain extender can be used to reduce a crystallization temperature and a crystallization degree of the thermoplastic polyurethane resin. Therefore, the laminating temperature of the thermoplastic polyurethane resin during the laminating process does not need to be high. Since the laminating temperature of the laminating process can be lowered, a thermal history and a degree of molecular weight decay of the thermoplastic polyurethane resin can be effectively improved. Furthermore, the abnormality of coarse grains, crystal points, and flow marks of the TPU film in the related art can be further improved.

In some embodiments of the present disclosure, a weight ratio between the first chain extender and the second chain extender ranges from 4.5 to 4.75:0.25 to 0.5, but the present disclosure is not limited thereto.

According to the amount of the chain extender component and the weight ratio between the first chain extender and the second chain extender, the thermoplastic polyurethane resin can have an ideal crystallinity and an ideal mechanical strength. If the amount of the chain extender component or the weight ratio between the first chain extender and the second chain extender exceeds the above-mentioned range, the crystallinity and the mechanical strength of the thermoplastic polyurethane resin may be adversely affected.

The chain terminator component is a monohydric alcohol having a carbon chain length of C4 to C18. For example, the chain terminator component is at least one material selected from a group consisting of: 1-butanol, 1-octanol, 1-dodecanol (also referred to as lauryl alcohol), and 1-octadecanol (also referred to as stearyl alcohol).

The purpose of adding the chain terminator component is to terminate the polymerization reaction after the thermoplastic polyurethane resin reaches a predetermined molecular weight in the polymerization reaction, so that the polymerization reaction can be complete. In this way, a molecular weight of the thermoplastic polyurethane resin can be maintained in a stable state, and a molecular weight distribution of the thermoplastic polyurethane resin can become more concentrated.

Furthermore, since the molecular weight of the thermoplastic polyurethane resin can be maintained in the stable state and be prevented from rising continuously, the thermoplastic polyurethane resin is less likely to have coarse particles or crystal points.

In some embodiments of the present disclosure, an NCO/OH equivalent ratio of the reaction mixture in the polymerization reaction must be controlled within a specific range, so that the thermoplastic polyurethane resin can have a stable molecular weight, a narrow molecular weight distribution, and a good processing fluidity.

More specifically, the NCO/OH equivalent ratio of the reaction mixture in the polymerization reaction is controlled preferably between 0.98 and 1.02, and more preferably between 0.995 and 1.005.

If the NCO/OH equivalent ratio exceeds the above range (i.e., the amount of the isocyanate component is excessive), the thermoplastic polyurethane resin tends to have problems, such as poor heat resistance and difficulty in processing. In addition, the TPU film made from the thermoplastic polyurethane resin by the laminating process is prone to having the abnormal characteristics (e.g., coarse grains, crystal points, and flow marks).

It should be noted that the isocyanate component has an isocyanate group (NCO group). The polyol component, the chain extender component, and the chain terminator component all have hydroxyl groups (OH groups). That is, the NCO/OH equivalent ratio is adjusted by controlling an amount ratio of the isocyanate component, the polyol component, the chain extender component, and the chain terminator component in the reaction mixture.

From another perspective, in the process of the polymerization reaction, the NCO/OH equivalent ratio must be continuously controlled within the above-mentioned specific range. Accordingly, the molecular weight of the thermoplastic polyurethane resin can be stabilized, and the molecular weight distribution of the thermoplastic polyurethane resin can be concentrated.

It is worth mentioning that the thermoplastic polyurethane resin of the present embodiment can be made into colloidal particles after being synthesized, and is particularly suitable for being formed into the thermoplastic polyurethane film through the laminating process. Said thermoplastic polyurethane film does not have the abnormal characteristics (e.g., coarse grains, crystal points, and flow marks).

Further, to enable the thermoplastic polyurethane resin of the present embodiment to be more suitable for the laminating process (which results in formation of a thermoplastic polyurethane film with good quality and appearance), the thermoplastic polyurethane resin needs to satisfy the following conditions.

(1) A ratio (Mw/Mn) between a weight average molecular weight (Mw) and a number average molecular weight (Mn) of the thermoplastic polyurethane resin analyzed by a gel permeation chromatography (GPC) is between 1.250 and 1.300, and is preferably between 1.280 and 1.290.

The “ratio (Mw/Mn) between the weight average molecular weight (Mw) and the number average molecular weight (Mn)” is one variety of polydispersity indices.

Compared with the thermoplastic polyurethane resin currently available on the market, the thermoplastic polyurethane resin of the present embodiment has a relatively narrow molecular weight distribution.

(2) A crystallinity of the thermoplastic polyurethane resin analyzed by a differential scanning calorimeter (DSC) is between 10% and 30%, and is preferably between 20% and 25%.

The “crystallinity” represents a proportion of a crystalline part in a polymer to the total polymer, and is expressed by a formula: crystallinity=crystalline part/(crystalline part+non-crystalline part).

Compared with the thermoplastic polyurethane resin currently available on the market, the thermoplastic polyurethane resin of the present embodiment has a relatively low crystallinity, so as to improve problems of coarse particles and crystal points.

(3) A melt flow index (MFI) of the thermoplastic polyurethane resin is between 5 g/10 min (190° C.) and 8 g/10 min (190° C.), and is preferably between 6 g/10 min (190° C.) and 7 g/10 min (190° C.).

The “melt flow index” in the present application refers to a weight of a thermoplastic resin passing through a standard die every 10 minutes on a melt flow velocimeter at a temperature of 190° C., which is expressed as g/10 min (190° C.). The melt flow index indicates the fluidity of the resin in a molten state. The larger the melt flow index, the smaller the molecular weight and the better the fluidity.

In the present embodiment, a change rate of the melt flow index of the thermoplastic polyurethane resin needs to be controlled within ±1%, so as to ensure that the resin has good processability, does not have too many crystal points, and does not have too many flow marks during the laminating process.

(4) A viscosity change rate of the thermoplastic polyurethane resin analyzed by a dynamic mechanical analyzer (DMA) under test conditions of a constant temperature of 190° C. and a shear rate of 0 to 1000 s−1 is between 300 (Ns)/m² and 600 (Ns)/m², and is preferably between 400 (Ns)/m² and 500 (Ns)/m².

The dynamic mechanical analyzer is used to observe strength, viscosity, elasticity, and various phase transition characteristics of materials by applying variables (such as temperature, shear force, frequency and deformation) to a sample.

Compared with the thermoplastic polyurethane resin currently available on the market, the thermoplastic polyurethane resin of the present embodiment has a relatively low viscosity change rate.

(5) A softening temperature of at least 95 wt. % of resin components in the thermoplastic polyurethane resin is lower than the laminating temperature of the laminating process. The softening temperature is between 150° C. and 180° C., and the laminating temperature is between 170° C. and 200° C. Accordingly, most of the thermoplastic polyurethane resin can be softened at the laminating temperature, thereby reducing the generation of coarse particles or crystal points.

From a polymer structure perspective, a polymer chain of the thermoplastic polyurethane resin includes at least one short chain segment, at least one long chain segment, at least one first extension segment, at least one second extension segment, and at least one chain termination segment that are randomly distributed. The short chain segment is formed of residues of a first polyol except for hydroxyl groups, and the long chain segment is formed of residues of a second polyol except for hydroxyl groups. The first polyol has a first number average molecular weight, the second polyol has a second number average molecular weight, the first number average molecular weight is between 600 g/mol and 2,000 g/mol, the second number average molecular weight is between 1,500 g/mol and 3,000 g/mol, the first number average molecular weight is less than the second number average molecular weight, and a difference between the first number average molecular weight and the second number average molecular weight is between 500 g/mol and 1,000 g/mol. The first extension segment is formed of residues of a first chain extender except for hydroxyl groups, and the second extension segment is formed of residues of a second chain extender except for hydroxyl groups. The first chain extender has a carbon chain length of C2 to C6, and a molecular structure of the first chain extender is linear and symmetrical. The second chain extender has a carbon chain length of C3 to C10, and a molecular structure of the second chain extender has at least a side chain and/or at least an ether group. The chain termination segment is formed of residues of a chain terminator component except for hydroxyl groups, the chain terminator component is a monohydric alcohol having a carbon chain length of C4 to C18, and the chain termination segment is located at a tail end of the polymer chain.

Compared with the thermoplastic polyurethane resin currently available on the market, the thermoplastic polyurethane resin of the present embodiment has a relatively narrow molecular weight distribution, so that the softening temperature of the resin is relatively concentrated.

In the present embodiment, most of a polyurethane resin component has a softening temperature (from 150° C. to 180° C.) that is significantly lower than the laminating temperature (from 170° C. to 200° C.). Therefore, a melt flowability of the heated and melted polyurethane resin component is good. In addition, shaping of the cooled polyurethane resin component is easy, so that a thickness uniformity of the product can be improved.

[Method for Producing Thermoplastic Polyurethane Resin]

The above is a description related to the material characteristics of the thermoplastic polyurethane resin of the embodiment of the present disclosure, and a method for producing the thermoplastic polyurethane resin of the embodiment of the present disclosure will be provided below.

The method for producing the thermoplastic polyurethane resin includes step S110, step S120, and step S130. It should be noted that the sequence of each step and the actual operation way described in the present embodiment can be adjusted according to requirements, and the present disclosure is not limited to what is described in the following examples.

The step 110 includes: adding an isocyanate component, a polyol component, and a chain extender component into an extruder (i.e., a twin screw extruder), respectively, to form a reaction mixture.

The amounts and the material characteristics of the isocyanate component, the polyol component, and the chain extender component have been described in detail above, and will not be repeated herein.

The step S120 includes: performing a polymerization reaction on the reaction mixture in the extruder to increase a molecular weight of the reaction mixture, so that the reaction mixture is formed into a thermoplastic polyurethane resin. An NCO/OH equivalent ratio of the reaction mixture in the polymerization reaction is controlled to be between 0.98 and 1.02 through monitoring an instant viscosity of a melt of the reaction mixture online and through correspondingly adjusting feeding amounts of the isocyanate component, the polyol component, and the chain extender component.

The NCO/OH equivalent ratio of the reaction mixture in the polymerization reaction must be controlled within the specific range mentioned above, so that the thermoplastic polyurethane resin can have a stable molecular weight, a narrow molecular weight distribution, and a good processing fluidity. The polymerization reaction allows the hydroxyl groups (—OH) of the polyol component and the chain extender component to react with the isocyanate group (—NCO) of the isocyanate component, so as to form a polymer containing urethane characteristic units in the main chain.

The step S130 includes: adding a chain terminator component into the extruder to terminate the polymerization reaction when the thermoplastic polyurethane resin reaches a predetermined molecular weight (i.e., between 70,000 and 150,000) or a predetermined viscosity (i.e., between 300 Pa·s and 800 Pa.$) in the polymerization reaction; and extruding the thermoplastic polyurethane resin through the extruder to form a product having a colloidal shape.

Accordingly, the molecular weight of the thermoplastic polyurethane resin can be maintained in a stable state, and the molecular weight distribution of the thermoplastic polyurethane resin can become more concentrated.

Furthermore, since the molecular weight of the thermoplastic polyurethane resin can be maintained in a stable state and be prevented from rising continuously, the thermoplastic polyurethane resin is less likely to have coarse particles or crystal points.

It is worth mentioning that, in the related art, the thermoplastic polyurethane resin currently available on the market is formed by pelletizing through a twin-screw extruder, which generally has the following problems. Mixing and reaction of the reaction mixture are carried out simultaneously, and the time that the reaction mixture is retained in the twin-screw extruder is limited, thereby resulting in an incomplete reaction of the product. A laminated product is prone to having coarse grains and crystal points. TPU colloidal particles have a high crystallinity, and the laminating temperature needs to be increased. Therefore, the film produced in this manner tends to have flow marks, and the thickness of the film can easily become non-uniform.

Compared with the related art, the method for producing the thermoplastic polyurethane resin of the present embodiment optimizes the extrusion conditions, so that the NCO/OH equivalent ratio is optimized and the polymerization reaction for forming the thermoplastic polyurethane resin can be more complete. Accordingly, the occurrence of coarse particles and crystal points can be prevented.

The method for producing the thermoplastic polyurethane resin of the present embodiment is to quantitatively pour three kinds of liquids into a reaction extruder, and the thermoplastic polyurethane resin is produced by water cutting and granulation. As for the conditions of the extrusion process, the viscosity of the discharged melt must meet control requirements of a finished product.

In general, the thermoplastic polyurethane resin of the present embodiment has a narrow molecular weight distribution, a low softening temperature, and a small melt viscosity change rate. The colloidal particles of the thermoplastic polyurethane resin have good processability. After the thermoplastic polyurethane resin is processed into a film by lamination, the film does not have crystal points and flow marks, and has good thickness uniformity and hydrolysis resistance.

[Experimental Data Test]

Hereinafter, a detailed description will be provided with reference to Exemplary Examples 1 to 4 and Comparative Examples 1 to 3. However, the following examples are provided only to aid in understanding of the present disclosure, and are not to be construed as limiting the scope of the present disclosure.

In Exemplary Example 1, the reaction mixture employs two polyols with different number average molecular weights, and a second chain extender is introduced. In Exemplary Example 2, the process conditions are substantially the same as those of Exemplary Example 1, except that a hard chain ratio is increased and polyols with different number average molecular weights are used. In Exemplary Example 3, the process conditions are substantially the same as those of Exemplary Example 1, except that a different second chain extender is used. In Exemplary Example 4, the process conditions are substantially the same as those of Exemplary Example 1, except that two polyols with different number average molecular weights are used in different proportions. The process conditions of Comparative Examples 1 to 3 are inferior. In Comparative Example 1, the process conditions are substantially the same as those of Exemplary Example 1, except that the second chain extender is not used. In Comparative Example 2, the process conditions are substantially the same as those of Exemplary Example 1, except that only a single polyol is used. In Comparative Example 3, the process conditions are substantially the same as those of Exemplary Example 1, except that the NCO/OH equivalent is reduced.

Manufacturing parameters and conditions of each component are shown in Table 1 below.

Then, physical and chemical properties of the thermoplastic polyurethane resins prepared in Exemplary Examples 1 to 4 and Comparative Examples 1 to 3 are tested, which include: Mw/Mn, crystallinity (%), melt flow index (g/10 min (190° C.)), viscosity change rate (N·s)/m², and peak softening temperature (° C.). The relevant test methods have been described above, and the test results are summarized in Table 1 below.

TABLE 1
[Experimental conditions and test results]

| | | Exemplary | Exemplary | Exemplary | Exemplary | Comparative | Comparative | Comparative |
|---|---|---|---|---|---|---|---|---|
| Item | | Example 1 | Example 2 | Example 3 | Example 4 | Example 1 | Example 2 | Example 3 |
| reaction mixture | type of isocyanate | MDI | MDI | MDI | MDI | MDI | MDI | MDI |
| | amount of isocyanate | 31.9 | 33.2 | 31.7 | 31.6 | 31.8 | 31.6 | 31.3 |
| | (parts by weight) | | | | | | | |
| | type of first polyol | polyester | polyester | polyester | polyester | polyester | polyester | polyester |
| | | polyol | polyol | polyol | polyol | polyol | polyol | polyol |
| | Mn of first polyol | 600 | 1000 | 600 | 600 | 1000 | — | 600 |
| | amount of | 10.1 | 9.8 | 10.1 | 5.0 | 10.1 | 0 | 10.1 |
| | first polyol | | | | | | | |
| | (parts by weight) | | | | | | | |
| | type of second polyol | polyester | polyester | polyester | polyester | polyester | polyester | polyester |
| | | polyol | polyol | polyol | polyol | polyol | polyol | polyol |
| | Mn of second polyol | 2000 | 2000 | 1500 | 1500 | 2500 | 2000 | 2000 |
| | amount of | 52.9 | 51.2 | 52.9 | 58.0 | 52.9 | 62.0 | 52.9 |
| | second polyol | | | | | | | |
| | (parts by weight) | | | | | | | |
| | type of | 14BG | 14BG | 14BG | 14BG | 14BG | 14BG | 14BG |
| | first chain extender | | | | | | | |
| | Mn of | 90 | 90 | 90 | 90 | 90 | 90 | 90 |
| | first chain extender | | | | | | | |
| | amount of | 4.7 | 5.3 | 4.6 | 4.8 | 5.2 | 4.9 | 5.0 |
| | first chain extender | | | | | | | |
| | (parts by weight) | | | | | | | |
| | type of | 13PG | 13PG | DEG | DEG | — | 13PG | 13PG |
| | second chain extender | | | | | | | |
| | Mn of | 76 | 76 | 106 | 106 | — | 76 | 76 |
| | second chain extender | | | | | | | |
| | amount of | 0.43 | 0.49 | 0.61 | 0.63 | — | 0.51 | 0.51 |
| | second chain | | | | | | | |
| | extender (parts by weight) | | | | | | | |
| | type of chain | stearyl | stearyl | stearyl | stearyl | stearyl | stearyl | stearyl |
| | terminator | alcohol | alcohol | alcohol | alcohol | alcohol | alcohol | alcohol |
| | Mn of chain terminator | 270 | 270 | 270 | 270 | 270 | 270 | 270 |
| | amount of | 0.01 | 0.03 | 0.03 | 0.03 | 0.03 | 0.03 | 0.03 |
| | chain terminator | | | | | | | |
| | (parts by weight) | | | | | | | |
| | NCO/OH | 1.005 | 1.005 | 1.005 | 1.005 | 1.005 | 1.005 | 0.995 |
| | equivalent ratio | | | | | | | |
| Test Results of | Mw/Mn | 110543 | 108326 | 114574 | 120047 | 109887 | 114125 | 77540 |
| TPU resin | crystallinity (%) | 15 | 18 | 13 | 16 | 26 | 32 | 38 |
| | melt flow index | 4.6 | 5.1 | 4.3 | 4.1 | 5.0 | 4.4 | 10.2 |
| | (g/10 min (190° C.)) | | | | | | | |
| | viscosity change rate | 12% | 11% | 11% | 10% | 18% | 19% | 24% |
| | (N · s)/m² | | | | | | | |
| | peak softening | 142 | 149 | 141 | 140 | 162 | 168 | 170 |
| | temperature (° C.) | | | | | | | |

[Test Results and Discussion]

In Exemplary Embodiments 1 to 4, two kinds of polyols are introduced, the second chain extender is added, the viscosity change rate of the TPU colloidal particles is between 10% and 12%, and the softening temperature is between 140° C. and 149° C. The TPU resin is introduced into a laminating process for forming a TPU film that has good molding fluidity. The appearance of the TPU film is free of coarse particles and crystal points, and the TPU film has an improved transparency.

In Comparative Examples 1 to 3, one single polyol is added, the second chain extender is not added or the NCO/OH equivalent ratio is reduced, the softening temperature of the TPU resin is increased to be between 162° C. and 170° C., the viscosity change rate is increased to be between 18% and 24%, and a laminating processing torque is high. Thus, the TPU resin has poor molding fluidity, and the TPU film has an inferior transparency due to a high crystallinity.

### Beneficial Effects of the Embodiments

In conclusion, in the thermoplastic polyurethane resin suitable for the laminating process and the method for producing the same provided by the present disclosure, by virtue of “the polyol component includes a first polyol and a second polyol, the first polyol has a first number average molecular weight, the second polyol has a second number average molecular weight, the first number average molecular weight is between 600 g/mol and 2,000 g/mol, and the second number average molecular weight is between 1,500 g/mol and 3,000 g/mol, the first number average molecular weight is less than the second number average molecular weight, and a difference between the first number average molecular weight and the second number average molecular weight is between 500 and 1,000 g/mol,” and “the chain extender component includes a first chain extender and a second chain extender, the first chain extender is a dihydric alcohol having a carbon chain length of C2 to C6, and a molecular structure of the first chain extender is linear and symmetrical, the second chain extender is a dihydric alcohol having a carbon chain length of C3 to C10, and a molecular structure of the second chain extender has at least a side chain and/or at least an ether group,” and “the chain terminator component is a monohydric alcohol having a carbon chain length of C4 to C18,” the thermoplastic polyurethane resin can have a narrow molecular weight distribution, a low softening temperature, and a small melt viscosity change rate. In addition, colloidal particles made of the thermoplastic polyurethane resin can have good processability. After the thermoplastic polyurethane resin is processed into a film by the laminating process, the film does not have crystal points and flow marks, and can have good thickness uniformity and hydrolysis resistance.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A thermoplastic polyurethane resin suitable for a laminating process, characterized in that the thermoplastic polyurethane resin is formed from a reaction mixture via a polymerization reaction, and the reaction mixture includes:
an isocyanate component;
a polyol component, the polyol component including a first polyol and a second polyol; wherein the first polyol has a first number average molecular weight, the second polyol has a second number average molecular weight, the first number average molecular weight is between 600 g/mol and 2,000 g/mol, and the second number average molecular weight is between 1,500 g/mol and 3,000 g/mol; wherein the first number average molecular weight is less than the second number average molecular weight, and a difference between the first number average molecular weight and the second number average molecular weight is between 500 g/mol and 1,000 g/mol;
a chain extender component, the chain extender component including a first chain extender and a second chain extender; wherein the first chain extender is a dihydric alcohol having a carbon chain length of from C2 to C6, and a molecular structure of the first chain extender is linear and symmetrical; wherein the second chain extender is a dihydric alcohol having a carbon chain length of from C3 to C10, and a molecular structure of the second chain extender has at least one side chain and/or at least one ether group; and
a chain terminator component, the chain terminator component being a monohydric alcohol having a carbon chain length of from C4 to C18.

2. The thermoplastic polyurethane resin according to claim 1, wherein, based on a total weight of the reaction mixture being 100 parts by weight, an amount of the isocyanate component is between 30 parts by weight and 35 parts by weight, an amount of the polyol component is between 60 parts by weight and 65 parts by weight, an amount of the chain extender component is between 5 parts by weight and 10 parts by weight, and an amount of the chain terminator component is between 0.01 parts by weight and 0.05 parts by weight.

3. The thermoplastic polyurethane resin according to claim 1, wherein a weight ratio between the first polyol and the second polyol ranges from 8 to 12:48 to 52, and the first polyol having the first number average molecular weight promotes lowering of a softening temperature of the thermoplastic polyurethane resin.

4. The thermoplastic polyurethane resin according to claim 1, wherein the first polyol is a first polyester polyol, and is at least one material selected from a group consisting of: poly(1,4-butylene adipate), polyethylene-1,4-butylene adipate glycol, and poly(1,6-hexamethylene adipate-succinic acid); wherein the second polyol is a second polyester polyol, and is at least one material selected from the group consisting of: poly(1,4-butylene adipate), polyethylene-1,4-butylene adipate glycol, and poly(1,6-hexamethylene adipate-succinic acid).

5. The thermoplastic polyurethane resin according to claim 4, wherein a main chain of the first polyol and/or the second polyol is further branched by a short-chain diol to form an asymmetric molecular structure.

6. The thermoplastic polyurethane resin according to claim 1, wherein the first chain extender is at least one material selected from a group consisting of 1,4-butanediol and ethylene glycol, the second chain extender is at least one material selected from a group consisting of 2-methyl-1,3-propanediol, neopentyl glycol, 3-methyl-1,5-pentanediol, diethylene glycol, and dipropylene glycol, a weight ratio between the first chain extender and the second chain extender ranges from 4.5 to 4.75:0.25 to 0.5, and the second chain extender having the at least one side chain and/or the at least one ether group promotes reducing of a crystallinity of the thermoplastic polyurethane resin.

7. The thermoplastic polyurethane resin according to claim 1, wherein the chain terminator component is at least one material selected from a group consisting of 1-butanol, 1-octanol, 1-dodecanol and 1-octadecanol.

8. The thermoplastic polyurethane resin according to claim 1, wherein an NCO/OH equivalent ratio of the reaction mixture in the polymerization reaction is between 0.98 and 1.02.

9. The thermoplastic polyurethane resin according to claim 1, wherein the thermoplastic polyurethane resin satisfies following conditions:
(1) a ratio (Mw/Mn) between a weight average molecular weight (Mw) and a number average molecular weight (Mn) of the thermoplastic polyurethane resin analyzed by a gel permeation chromatography (GPC) is between 1.250 and 1.300;
(2) a crystallinity of the thermoplastic polyurethane resin analyzed by a differential scanning calorimeter (DSC) is between 10% and 30%;
(3) a melt flow index (MFI) of the thermoplastic polyurethane resin is between 5 g/10 min (190° C.) and 8 g/10 min (190° C.);
(4) a viscosity change rate of the thermoplastic polyurethane resin analyzed by a dynamic mechanical analyzer (DMA) under test conditions of a constant temperature of 190° C. and a shear rate of 0 to 1000 s⁻¹ is between 300 (Ns)/m² and 600 (Ns)/m²; and
(5) a softening temperature of at least 95 wt. % of resin components in the thermoplastic polyurethane resin is lower than a laminating temperature of the laminating process, wherein the softening temperature is between 150° C. and 180° C., and the laminating temperature is between 170° C. and 200° C.

10. A thermoplastic polyurethane resin suitable for a laminating process, characterized in that a polymer chain of the thermoplastic polyurethane resin includes: at least one short chain segment, at least one long chain segment, at least one first extension segment, at least one second extension segment, and at least one chain termination segment;
wherein the at least one short chain segment is formed of residues of a first polyol except for hydroxyl groups, the at least one long chain segment is formed of residues of a second polyol except for hydroxyl groups, the first polyol has a first number average molecular weight, the second polyol has a second number average molecular weight, the first number average molecular weight is between 600 g/mol and 2,000 g/mol, the second number average molecular weight is between 1,500 g/mol and 3,000 g/mol, the first number average molecular weight is less than the second number average molecular weight, and a difference between the first number average molecular weight and the second number average molecular weight is between 500 g/mol and 1,000 g/mol;
wherein the at least one first extension segment is formed of residues of a first chain extender except for hydroxyl groups, the at least one second extension segment is formed of residues of a second chain extender except for hydroxyl groups, the first chain extender has a carbon chain length of from C2 to C6, a molecular structure of the first chain extender is linear and symmetrical, the second chain extender has a carbon chain length of from C3 to C10, and a molecular structure of the second chain extender has at least one side chain and/or at least one ether group;
wherein the at least one chain termination segment is formed of residues of a chain terminator component except for hydroxyl groups, the chain terminator component is a monohydric alcohol having a carbon chain length of from C4 to C18, and the at least one chain termination segment is located at a tail end of the polymer chain.

11. A method for producing a thermoplastic polyurethane resin suitable for a laminating process, the method comprising:
respectively adding an isocyanate component, a polyol component, and a chain extender component into an extruder to form a reaction mixture;
performing a polymerization reaction on the reaction mixture in the extruder to increase a molecular weight of the reaction mixture, so that the reaction mixture is formed into the thermoplastic polyurethane resin; wherein an NCO/OH equivalent ratio of the reaction mixture in the polymerization reaction is controlled to be between 0.98 and 1.02; and
adding a chain terminator component into the extruder to terminate the polymerization reaction when the thermoplastic polyurethane resin reaches a predetermined molecular weight or a predetermined viscosity in the polymerization reaction;
wherein the polyol component includes a first polyol and a second polyol, the first polyol has a first number average molecular weight, the second polyol has a second number average molecular weight, the first number average molecular weight is between 600 g/mol and 2,000 g/mol, and the second number average molecular weight is between 1,500 g/mol and 3,000 g/mol; wherein the first number average molecular weight is less than the second number average molecular weight, and a difference between the first number average molecular weight and the second number average molecular weight is between 500 g/mol and 1,000 g/mol;
wherein the chain extender component includes a first chain extender and a second chain extender, the first chain extender is a dihydric alcohol having a carbon chain length of from C2 to C6, and a molecular structure of the first chain extender is linear and symmetrical; wherein the second chain extender is a dihydric alcohol having a carbon chain length of from C3 to C10, and a molecular structure of the second chain extender has at least one side chain and/or at least one ether group; wherein the chain terminator component is a monohydric alcohol having a carbon chain length of from C4 to C18.
